(19) United States
(12) Patent Application Publication
(10) Pub. No.: US 2010/0149694 A1
(43) Pub. Date: Jun. 17, 2010

(54) DISK DEVICE

(75) Inventor: Hiroshi SUZUKI, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/711,027

(22) Filed: Feb. 23, 2010

Related U.S. Application Data
(63) Continuation of application No. PCT/JP2007/066471, filed on Aug. 24, 2007.

(51) Int. Cl. G11B 5/54

(52) U.S. Cl. 360/256.2; G9B/5.181

(57) ABSTRACT

According to an embodiment, a disk device includes a latch mechanism configured to retract a head on a distal end portion of an actuator to a ramp mechanism and latch a ferromagnetic member disposed on the actuator on the side of a motor coil by a latch magnet, a shaft protruding from that part of a base of the disk device which is located near the latch mechanism, and a rotary lever pivotably mounted on the shaft. The rotary lever includes a first arm on the disk side being extended over the disk so that the rotary lever is rotated by a pressure of airflow produced as the disk rotates, and a second arm on the latch magnet side configured to move as the rotary lever is rotated by the airflow pressure, to weaken magnetic coupling between the latch magnet and the ferromagnetic member.

### CROSS REFERENCE TO RELATED APPLICATIONS

This is a Continuation Application of PCT Application No. PCT/JP2007/066471, filed Aug. 24, 2007, which was published under PCT Article 21(2) in Japanese.

### BACKGROUND

1. Field

An embodiment of the invention relates to a disk device, and more particularly, to a load/unload magnetic disk device comprising a latch mechanism for latching a head actuator outside a magnetic disk when the head actuator is unloaded.

2. Description of the Related Art

A prevailing magnetic disk device as an external storage device for saving data for a computer is a hard disk device, which comprises a magnetic disk (hereinafter referred to simply as a disk) for data storage coated with a magnetic material and a magnetic head (hereinafter referred to simply as a head) for reading and writing data from and to the disk. A disk used in a hard disk device has a structure comprising a number of aluminum or glass disks coated with a magnetic material, and it is rotated at high speed by a motor so that data can be read and written by the head.

Hard disk devices include contact-start-stop (CSS) hard disk devices and load/unload (or ramp-load) hard disk devices. In the CSS type, a head is in contact with a disk when the disk is stopped, flies above the disk when the disk rotates, and contacts the disk again when the disk rotation stops. In the load/unload type, a head disposed on the distal end of a head actuator (head stack assembly) is unloaded from above a disk when the disk is stopped, and it is loaded onto the disk when the disk rotates.

A load/unload hard disk device is configured so that a ramp mechanism provided on a base near the outer periphery of the disk is caused to hold a lift tab protruding from the distal end of the head. Further, a latch mechanism that utilizes the force of attraction of a magnet is provided on the voice coil motor side of the head actuator to prevent the head, when held by the ramp mechanism, from being disengaged from the ramp mechanism and colliding with the disk surface if the hard disk device is externally jolted when it is non-operating. One such latch mechanism is described as a magnet latch with reference to FIGS. 2 to 16 in page 62 of Non-patent Document: Hard Disk Drive Structure and Applications (edited by Hiroshi Okamura, CQ Publishing Co., Ltd.).

In a latch mechanism described in Jpn. Pat. Appln. KOKAI Publication No. 2000-313040, moreover, a latch groove is provided at a coil end portion of a voice coil motor opposite from a head, and a lever pivotally supported on a pin is pivotably disposed outside this coil end portion. A latch hook and magnet are disposed on one and the other ends, respectively, of the lever, and a magnet latch, comprising an electromagnet, and an inertia latch are jointly arranged outside the lever.

According to the latch mechanism described in Jpn. Pat. Appln. KOKAI Publication No. 2000-313040, the latch hook is caused to engage with the latch groove in such a manner that the magnet on the lever and a magnetic core of the electromagnet attract each other with the head held by the ramp mechanism when the disk is stationary. When the disk rotates, the electromagnet is energized so that the electromagnetic and magnet repel each other, thereby rotating the lever and releasing the latch hook from the latch groove.

Thus, the magnet latch described in Non-patent Document may be singly used as a latch system. If the magnetic force of the magnet is weak, however, the latch is disengaged by an external impact with the disk stopped, so that the head may separate from the rotary lever and collide with the disk. If the magnetic force of the magnet is enhanced to increase anti-shock acceleration, on the other hand, necessary current to be supplied to a magnetic circuit, in order to release the head actuator from the magnet latch in activating the disk, increases. Since the actuator cannot be released from the magnet latch if the current is low, the anti-shock acceleration can be improved only limitedly. If the actuator position under the influence of the latching force is caused to reach the disk surface by the increase of the magnetic force of the magnet, a correction current is needed to position the actuator, so that there is a problem of an increase in energy consumption.

Further, the latch mechanism that jointly uses the magnet latch and inertia latch, as described in Jpn. Pat. Appln. KOKAI Publication No. 2000-313040, requires use of an increased number of components, so that it is disadvantageous in cost and has a problem that the latch does not work when the mechanism is jolted prolongedly or continuously.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is an exemplary plan view showing a conventional load/unload magnetic disk device with its head loaded, and FIG. 1B is an exemplary plan view of the conventional load/unload magnetic disk device with the head unloaded;

FIG. 2A is an exemplary plan view of a load/unload magnetic disk device according to a first embodiment of the present invention with its head loaded, FIG. 2B is an exemplary perspective assembly view showing configurations of a rotary lever and shaft shown in FIG. 2A, and FIGS. 2C, 3D, 2E, and 2F are exemplary sectional views showing examples of the cross-sectional shape of the rotary lever;

FIG. 3A is an exemplary partial enlarged plan view showing a position (solid lines) of the rotary lever shown in FIG. 2A with disks stopped and a position (two-dot chain lines) with the disks rotating, FIG. 3B is an exemplary conceptual diagram of a magnetic field distribution between a latch magnet and a ferromagnetic member mounted on a head actuator with the disks stopped, as viewed laterally, and FIG. 3C is an exemplary conceptual diagram of a magnetic field distribution between the latch magnet and the ferromagnetic member mounted on the head actuator plus a latch plate mounted on one end of the rotary lever with the disks rotating, as viewed laterally;

FIG. 4 is an exemplary characteristic diagram showing torques produced between the latch magnet and the ferromagnetic member mounted on the head actuator according to the first embodiment of the present invention, as compared with the position of the head actuator with the disks non-operating and operating;

FIG. 5A is an exemplary partial enlarged plan view showing a position (solid lines) of a rotary lever according to a second embodiment of the present invention with disks stopped and a position (two-dot chain lines) with the disks rotating, and FIG. 5B is an exemplary perspective assembly view showing configurations of the rotary lever and a shaft shown in FIG. 5A;

FIG. 6A is an exemplary partial enlarged plan view showing a position (solid lines) of a rotary lever according to a third embodiment of the present invention with disks stopped and a position (two-dot chain lines) with the disks rotating, and FIG. 6B is an exemplary perspective assembly view showing configurations of the rotary lever and a shaft shown in FIG. 6A;

FIG. 7 is an exemplary characteristic diagram showing torques produced between a latch magnet and a ferromagnetic member mounted on a head actuator according to the third embodiment of the present invention, as compared with the position of the head actuator with disks non-operating and operating;

FIGS. 8 show an exemplary modification of the third embodiment of the present invention shown in FIG. 6A, in which FIG. 8A is an exemplary partial enlarged sectional view, and FIG. 8B is an exemplary partial enlarged plan view; and

FIG. 9 is an exemplary plan view showing an effect of the rotary lever of the magnetic disk device of the present invention.

### DETAILED DESCRIPTION

Various embodiments according to the invention will be described hereinafter with reference to the accompanying drawings. In general, according to one embodiment of the invention, there is provided a disk device comprising: a latch mechanism configured to retract a head on a distal end portion of an actuator to a ramp mechanism disposed near the outer periphery of a disk and latch a ferromagnetic member disposed on the actuator on the side of a motor coil by a latch magnet; a shaft protruding from that part of a base of the disk device which is located near the latch mechanism; and a rotary lever pivotably mounted on the shaft, the rotary lever comprising a first arm on the disk side being extended over the disk so that the rotary lever is rotated by a pressure of airflow produced as the disk rotates, and a second arm on the latch magnet side configured to move as the rotary lever is rotated by the airflow pressure, to weaken magnetic coupling between the latch magnet and the ferromagnetic member.

According to another aspect of the invention, there is provided a disk device comprising: a latch mechanism configured to retract a head on a distal end portion of an actuator to a ramp mechanism disposed near the outer periphery of a disk and latch a ferromagnetic member disposed on the actuator on the side of a motor coil by means of a latch magnet; a shaft protruding from that part of a base of the disk device which is located near the latch mechanism; and a rotary lever pivotably mounted on the shaft, the rotary lever comprising a first arm of the rotary lever on the disk side being extended over the disk so that the rotary lever is rotated by a pressure of airflow produced as the disk rotates, and a second arm on the latch magnet side, the latch magnet being mounted on an end portion of the second arm and configured to move away from the ferromagnetic member as the rotary lever is rotated by the airflow pressure.

According to the disk device of the embodiments, the external impact properties can be improved when the disk is non-operating, and the problem of unlatching of an inertia latch by continuous impact can be avoided. Since the number of components can be reduced, moreover, there is an advantage of cost reduction. At the same time, actuator starting current at the start of disk operation and actuator positioning correction current in data zones can be suppressed. Thus, requirements for high shock resistance, high reliability, low energy consumption, and low costs of the disk device can be met.

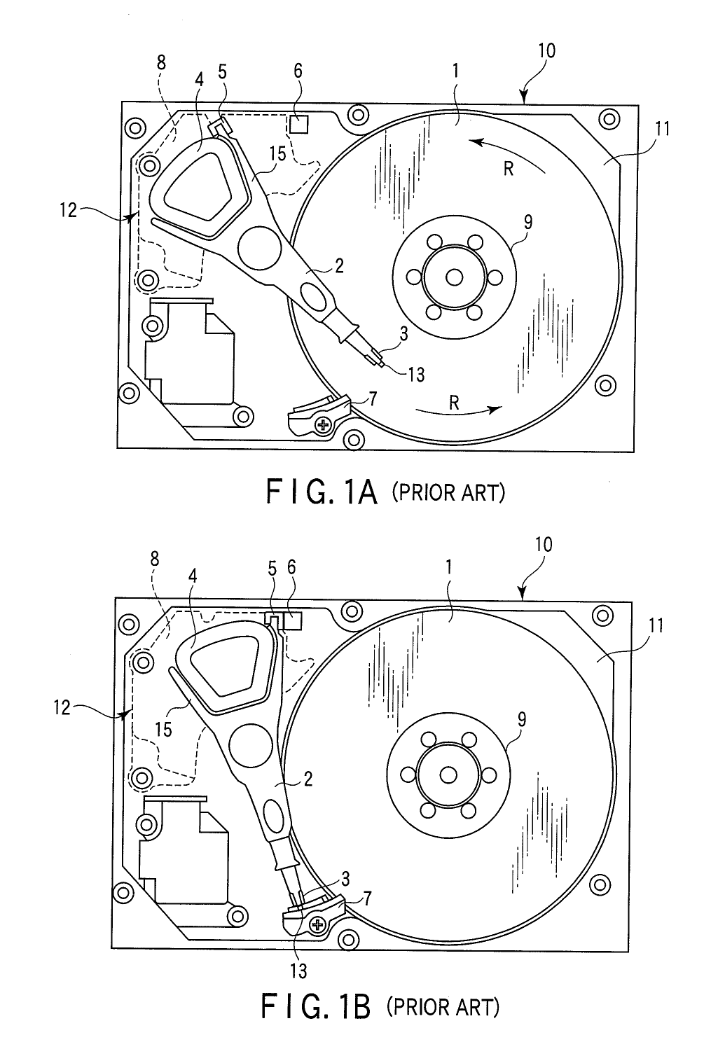

Embodiments of the present invention will now be described with reference to the drawings. Referring first to FIGS. 1A and 1B, there will be described a schematic configuration of a conventional load/unload magnetic disk device 10 and states of a head 3 with a disk 1 rotating and stationary. Numbers that denote constituent members used in the conventional magnetic disk device 10 to be described with reference to FIGS. 1A and 1B will also be used in the subsequent description of the embodiments of the present invention.

FIG. 1A shows an operating state (with the head loaded) of the conventional load/unload magnetic disk device 10. While the disk 1 is being rotated in the direction of arrow R by a spindle motor 9, the head 3 mounted on a distal end portion of a head actuator 2 accesses the disk 1. A lift tab 13 is provided on a part of the head actuator 2 more distal than the head 3. A VCM (voice coil motor) 12, which is formed of a coil 4 and magnetic circuit 8, is disposed on a rear end portion of the head actuator 2 opposite from the head 3, and the head 3 is positioned over the disk 1 by the VCM 12. A ramp mechanism 7 and latch magnet 6 are provided individually in predetermined positions on a base 11. Further, a ferromagnetic latch member 5 is mounted on a holding portion 15 for the coil 4 at the rear end portion of the head actuator on the side of the latch magnet 6.

FIG. 1B shows a non-operating state (with the head unloaded) of the conventional load/unload magnetic disk device 10. In this state, the rotation of the disk 1 is stopped, the head 3 mounted on the distal end portion of the head actuator 2 is moved to the outside of the disk 1 by the VCM 12, and the lift tab 13 is held by the ramp mechanism 7. Since the ferromagnetic latch member 5 is attracted to the latch magnet 6 in this state, moreover, the head actuator 2 is not easily movable in this state.

Thus, if the magnetic force of the latch magnet is enhanced to increase anti-shock acceleration, in the conventional load/unload magnetic disk device 10, current to be supplied to the VCM 12, in order to evacuate the head actuator 2 from the ramp mechanism 7 and load it onto the disk 1 in activating the disk 1, increases, so that there is a problem of an increase in energy consumption.

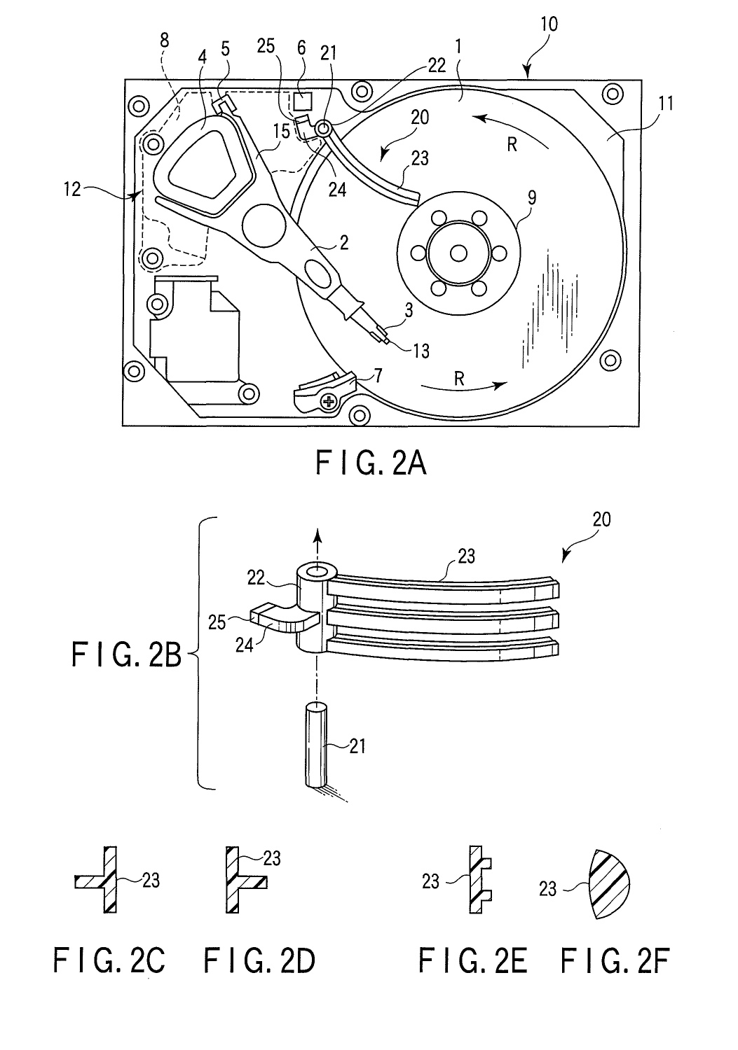

FIG. 2A shows an operating state (with the head loaded) of a load/unload magnetic disk device 10 according to one embodiment of the present invention. While a disk 1 is being rotated in the direction of arrow R by a spindle motor 9, a head 3 on a distal end portion of a head actuator 2, positioned by a VCM 12 formed of a coil 4 and magnetic circuit 8, accesses the disk 1. A ramp mechanism 7 and latch magnet 6 on a base 11 of the magnetic disk device 10 and a ferromagnetic latch member 5 on a holding portion 15 of the coil 4 on a rear end portion of the head actuator are positioned in the same manner as in the conventional case.

In the magnetic disk device 10 of this embodiment constructed in this manner, a shaft 21 that serves as a pivot protrudes from that part of the base 11 which is located between the latch magnet 6 and the outer periphery of the disk 1, and a rotary lever 20 is swingably mounted on the shaft 21. Details of the configuration of the rotary lever 20 are shown in FIG. 2B. The rotary lever 20 comprises a sleeve 22 through which the shaft 21 is passed. Windsail arms 23 are mounted on one side surface of the sleeve 22 so as to hold the disk 1 between them. Since two disks 1 are used in this embodiment, there are three windsail arms 23. This is because the more the windsail arms 23, the higher the rotational torque will be.

The windsail arms 23 are slightly curved so that airflow received thereby during the disk rotation is directed toward the latch magnet 6. Further, each windsail arm 23 should only be movable by the airflow that is produced as the disks 1 rotate, so that it is formed to be a flat plate with a rectangular cross section for the sake of reduced weight. However, the flat plate is provided with a rib lest it be deformed by the airflow. FIGS. 2C to 2F show some examples of the cross-sectional shape of the windsail arm 23. The rib may be located on either the side toward or away from the airflow. Further, the number of ribs is not limited to one. Furthermore, the cross-sectional shape of the windsail arm 23 may be such that it can control the airflow, as shown in FIG. 2F.

On the other hand, an auxiliary arm 24 is mounted on that side surface of the sleeve 22 which adjoins mounting portions for the windsail arms 23. The auxiliary arm 24 is curved so that its distal end is directed toward the latch magnet 6 after it first rises from the side surface of the sleeve 22 at right angles thereto. A ferromagnetic plate 25 that is attracted to the latch magnet 6 when approached thereby is mounted on the distal end of the auxiliary arm 24.

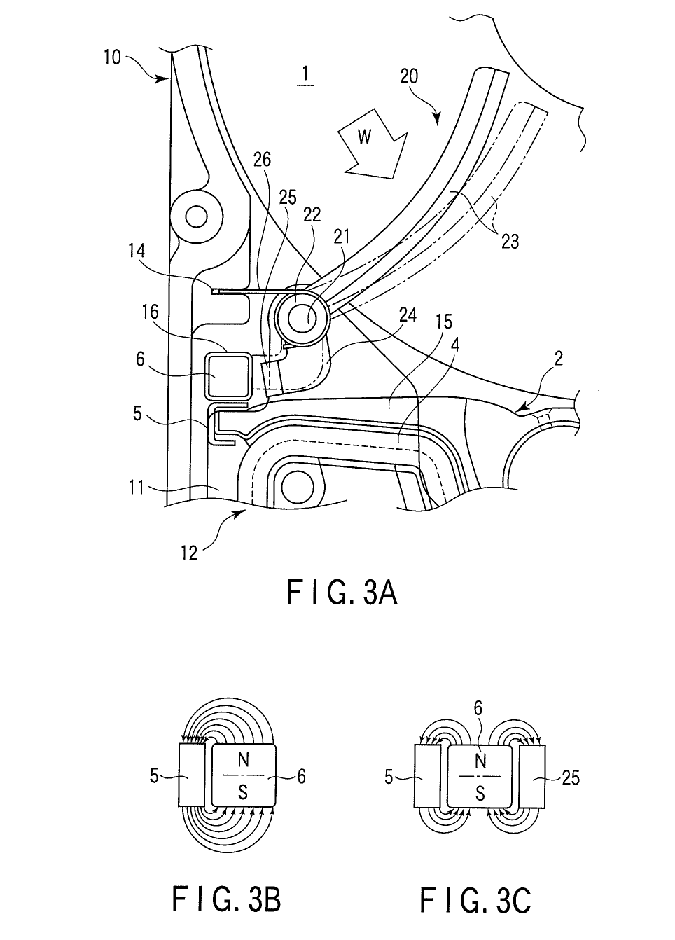

As shown in FIG. 3A, a coil spring 26 is mounted between the sleeve 22 of the rotary lever 20 passed through the shaft 21 and the base 11 of the magnetic disk device 10. One end of the coil spring 26 is fixedly held in a slit 14 in the base 11, while the other end is bent in a U-shape and fixed to the auxiliary arm 24. When the disks 1 are stationary, the rotary lever 20 is located back in its initial position indicated by solid lines by the urging force of the coil spring 26. Although a return spring mechanism based on the coil spring 26 is used in the first embodiment, the same effect can be obtained by using an alternative return mechanism.

The latch magnet 6 is fixed on that part of the base 11 which is located near the auxiliary arm 24 of the rotary lever 20. The circumference of the latch magnet 6 is covered by an elastic member 16. This is done because the latch magnet 6 serves as a stopper for regulating the rotation of the head actuator 2. While the disks 1 are stopped, the ferromagnetic latch member 5, which is mounted on the holding portion 15 of the head actuator 2, is attracted to one surface of the elastic member 16.

If the disks 1 rotate, the windsail arms 23 receive the pressure of airflow (indicated by arrow W) produced by the rotation of the disks 1 and rotate from a position indicated by solid lines to a position indicated by two-dot chain lines. When the windsail arms 23 rotate to the two-dot chain line position, the ferromagnetic plate 25 on the distal end of the auxiliary arm 24 contacts the elastic member 16 of the latch magnet 6. FIG. 3B is a conceptual diagram of a magnetic flux distribution between the latch magnet 6 and ferromagnetic latch member 5, as viewed laterally, in the case where the ferromagnetic plate 25 is kept apart from the latch magnet 6. FIG. 3C is a conceptual diagram of a magnetic flux distribution between the latch magnet 6 and ferromagnetic latch member 5, as viewed laterally, in the case where the ferromagnetic plate 25 contacts the elastic member 16 and approaches the latch magnet 6.

If the ferromagnetic plate 25 contacts the elastic member 16 and approaches the latch magnet 6, as seen from FIG. 3C, a magnetic flux dispersedly flows through the ferromagnetic latch member 5 and ferromagnetic plate 25. As a result, a magnetic flux between the latch magnet 6 and ferromagnetic latch member 5 is reduced, so that the force of the latch magnet 6 to attract the ferromagnetic latch member 5 is reduced, whereupon the ferromagnetic latch member 5 becomes easily separable from the latch magnet 6. Thus, the head actuator 2 is separated from the latch magnet 6 when the disks 1 are rotated, so that energy to be supplied to the VCM 12 can be reduced.

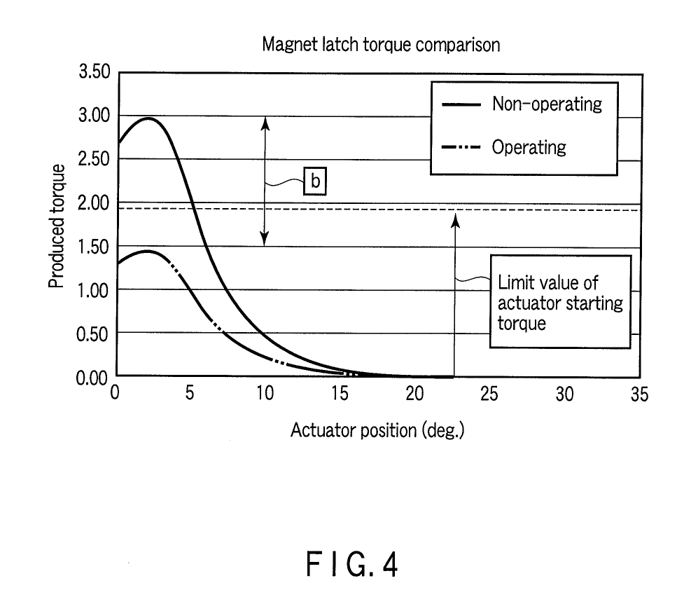

FIG. 4 comparatively shows latch torques according to the first embodiment described with reference to FIGS. 1A to 3C. The magnetic flux that flows through the ferromagnetic latch member 5 of the head actuator 2 is reduced from the state represented by a solid line to the state represented by a two-dot chain line as a ferromagnetic member (ferromagnetic plate 25) other than the ferromagnetic latch member 5 of the head actuator 2 approaches the vicinity of the latch magnet 6. Consequently, the latch torque with which the ferromagnetic latch member 5 is separated from the latch magnet 6, that is, the latch torque with which the head actuator 2 is separated from the latch magnet 6, is reduced as the ferromagnetic plate 25 approaches the latch magnet 6.

Thus, even if the magnetic latching force of the latch magnet 6 is set so as to exceed a limit value of the starting torque of the head actuator 2, which depends on the magnetic circuit capability of the head actuator 2, the latching force can be reduced to such a degree that the head actuator 2 can be started when the disks 1 are rotated by device operation. Therefore, requirements for improvement of the non-operating anti-shock performance of the magnetic disk device can be satisfied. Although the thin single auxiliary arm 24 is disposed only on the central part of the sleeve 22 according to the foregoing embodiment, the position, thickness, and number thereof should only be determined according to the degree of reduction of the magnetic force of the latch magnet 6.

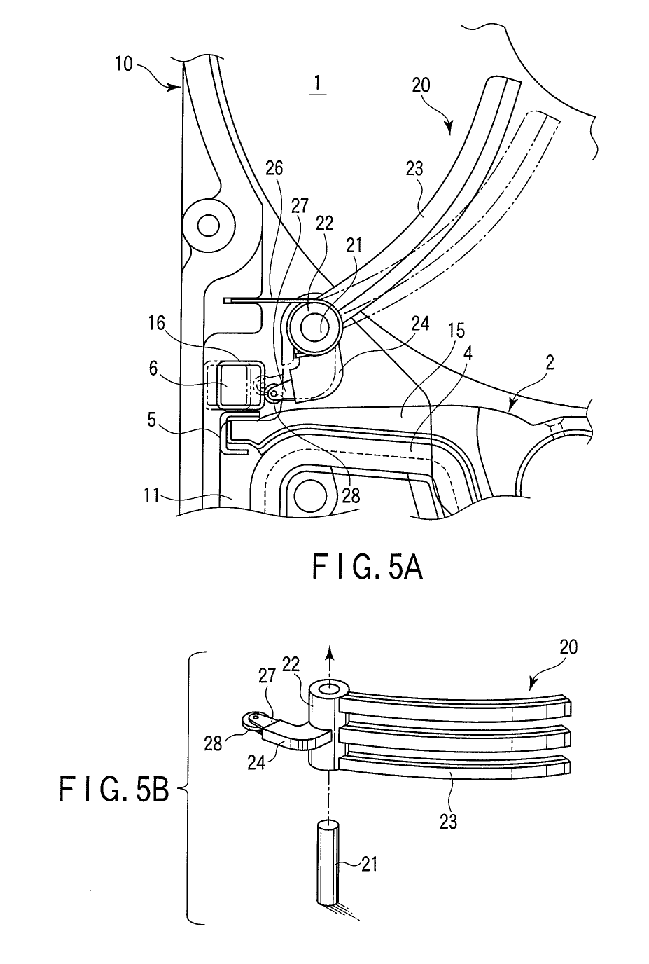

FIG. 5A illustrates a configuration of a rotary lever 20 according to a second embodiment of the present invention, and shows a region equivalent to that shown in FIG. 3A. Since the second embodiment differs from the first embodiment only in the respective configurations of the latch magnet 6 and the distal end of the auxiliary arm 24, like numbers are used to designate like portions and a description thereof is omitted.

In the first embodiment, the latch magnet 6 is fixed to the base 11, and the ferromagnetic plate 25 is mounted on the distal end of the auxiliary arm 24. In the second embodiment, in contrast with this, the latch magnet 6 is movably mounted on a base 11 so that it can slightly move to the outside of the base 11. Since a prior art mechanism can be used as a mechanism for the movement, its illustration is omitted. As shown in FIG. 5B, on the other hand, a bracket 27 is provided on the distal end of the auxiliary arm 24, and a roller 28 is rotatably mounted on the bracket 27. The bracket 27 and roller 28 are nonmagnetic bodies.

When the disks are stopped, in the second embodiment, a rotary lever 20 is in a position indicated by solid lines, and the roller 28 on the distal end of the auxiliary arm 24 is then in contact with an elastic member 16 of the latch magnet 6. If a magnetic disk device 10 is operated so that the disks 1 rotate, thereafter, the rotary lever 20 moves to a position indicated by two-dot chain lines. As this is done, the roller 28 moves pushing the latch magnet 6, thereby moving it to the outside of the base 11. As a result, an overlap between the latch magnet 6 and ferromagnetic latch member 5 becomes smaller, so that the force of the latch magnet 6 to attract the ferromagnetic latch member 5 is reduced, whereupon the ferromagnetic latch member 5 becomes easily separable from the latch magnet 6. Thus, a head actuator 2 is separated from the latch magnet 6 when the disks 1 are rotated, so that energy to be supplied to a VCM 12 can be reduced.

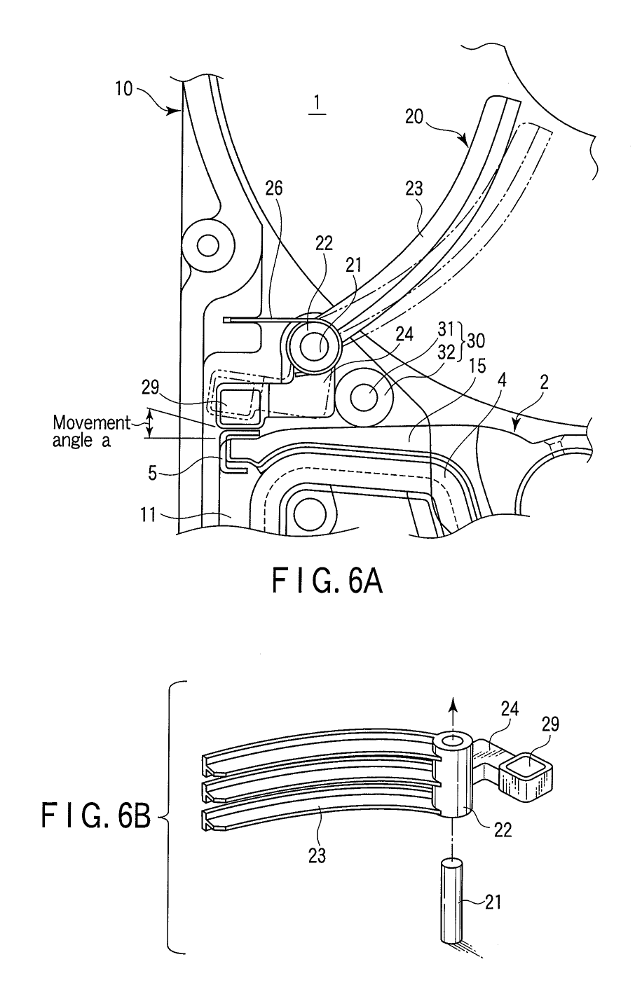

FIG. 6A illustrates a configuration of a rotary lever 20 according to a third embodiment of the present invention, and shows a region equivalent to that shown in FIG. 3A. Since the third embodiment differs from the first embodiment only in the respective configurations of the latch magnet 6 and the distal end of the auxiliary arm 24 and addition of an actuator stop 30, like numbers are used to designate like portions and a description thereof is omitted.

In the first embodiment, the latch magnet 6 is fixed to the base 11, and the ferromagnetic plate 25 is mounted on the distal end of the auxiliary arm 24. In the third embodiment, in contrast with this, the latch magnet 6 is movably mounted on the distal end of the auxiliary arm 24 so that it can move away from the latch magnet 6 as a rotary lever 20 moves. In the third embodiment, as shown in FIG. 5B, a latch magnet 29 is mounted on the distal end of the auxiliary arm 24. Further, the actuator stopper 30 is newly provided near a shaft 22 of the rotary lever 20. The actuator stopper 30 comprises a stopper shaft 31 protruding from the base 11 and a buffer 32 that covers its periphery.

When the disks are stopped, in the third embodiment, a rotary lever 20 is in a position indicated by solid lines, and the latch magnet 29 on the distal end of the auxiliary arm 24 is then in contact with a ferromagnetic latch member 5 on a holding portion 15 of a coil of a head actuator 2. In this state, a curved portion of the auxiliary arm 24 and the holding portion 15 of the coil of the head actuator 2 are in contact with the buffer 32 of the actuator stopper 30. If a magnetic disk device 10 is operated so that the disks 1 rotate, thereafter, the rotary lever 20 moves to a position indicated by two-dot chain lines, and the latch magnet 29 moves away from the ferromagnetic latch member 5. Consequently, the distance between the latch magnet 29 and ferromagnetic latch member 5 increases, so that the force of the latch magnet 29 to attract the ferromagnetic latch member 5 is reduced, whereupon the ferromagnetic latch member 5 becomes easily separable from the latch magnet 29. Thus, a head actuator 2 is separated from the latch magnet 29 when the disks 1 are rotated, so that energy to be supplied to a

VCM 12 can be reduced.

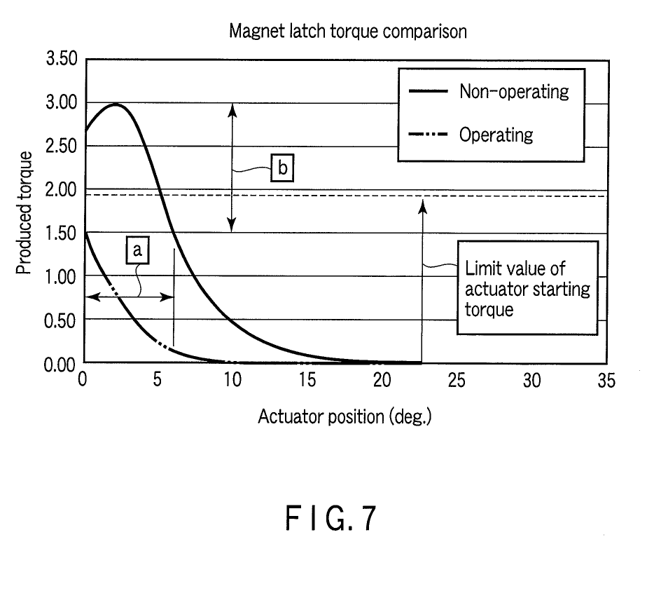

FIG. 7 comparatively shows latch torques according to the third embodiment described with reference to FIGS. 6A and 6B. The magnetic flux that flows through the ferromagnetic latch member 5 of the head actuator 2 is reduced from the state represented by a solid line to the state represented by a two-dot chain line as the latch magnet 29 moves away from the ferromagnetic latch member 5 of the head actuator 2.

Specifically, the latching force of the latch magnet 29 after the magnetic disk device 10 is activated so that the disks 1 are rotated can be set so that a torque is produced corresponding to a position moved by a movement angle “a” of the latch magnet 29 from the latched position of the latch magnet 29 with the disks 1 stationary, and that the starting torque of the head actuator 2 with the disks 1 rotating is lower than the stationary torque by a margin “b”.

Thus, even if the magnetic latching force of the latch magnet 29 is set so as to exceed a limit value of the starting torque of the head actuator 2, which depends on the magnetic circuit capability of the head actuator 2, the latching force can be reduced to such a degree that the head actuator 2 can be started when the disks 1 are rotated by device operation. Therefore, requirements for improvement of the non-operating anti-shock performance of the magnetic disk device can be satisfied.

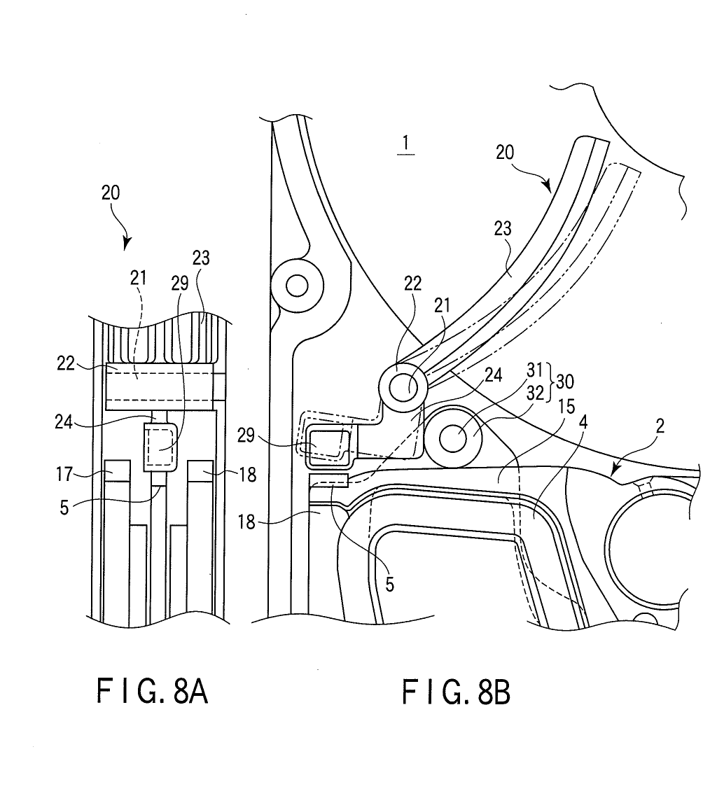

FIGS. 8A and 8B show a modification of the third embodiment of the present invention shown in FIG. 6A. FIG. 8B shows a region equivalent to that shown in FIG. 6A, and FIG. 8A shows a sectional view corresponding to FIG. 8B. In the third embodiment, the coil spring 26 is provided for returning the rotary lever 20 toward the actuator stopper 30 when the disks are stationary. According to the modification, on the other hand, the coil spring 26 is disused, and an upper yoke 17 and lower yoke 18 of a magnetic circuit of the head actuator 2 are used so that the rotary lever 20 is returned toward the actuator stopper 30 by a leakage flux from the movable latch magnet 29 and a force of magnetic attraction that acts between the upper and lower yokes 17 and 18. Consequently, in the modification, the coil spring 26 according to the third embodiment can be omitted. Although the ferromagnetic latch member 5 according to the modification shown in FIGS. 8A and 8B is in the form of a flat plate, it may alternatively be U-shaped.

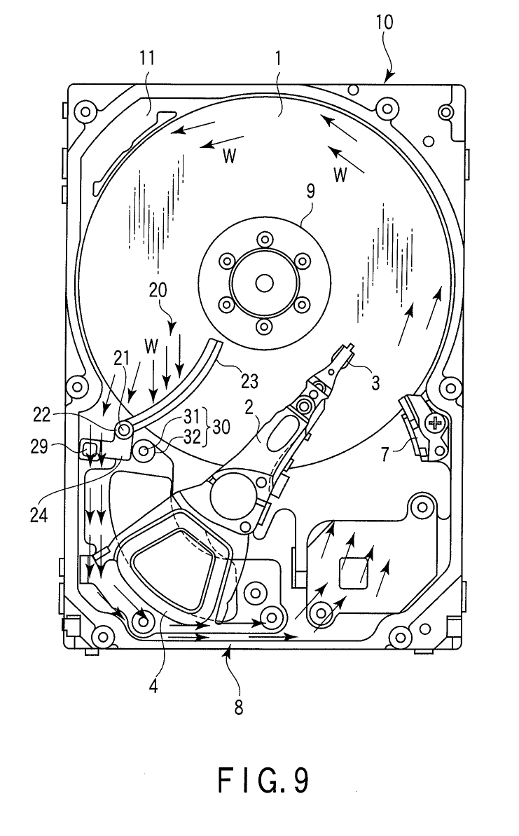

FIG. 9 shows airflow in the magnetic disk device 10 of the present invention based on the configuration according to the modification of the third embodiment. In the first to third embodiments of the present invention, as well as in the modification of the third embodiment, the windsail arms 23 of the rotary lever 20 are curved so that airflows (indicated by arrows W) produced by the rotation of the disks 1 are guided to a region behind the VCM 12 as the disks 1 rotate. Consequently, airflow W over the surface of each disk 1 is guided toward the magnetic circuit 8 outside the disk 1. Thus, a flow passage is formed that extends along a sidewall of the base 11 and returns to the disk 1, so that a cooling effect can be obtained for the coil 4 of the head actuator 2. Since the windsail arms 23 are located upstream relative to an arm portion of the head actuator 2, moreover, an air pressure that acts on the arm portion of the head actuator 2 can be reduced, so that vibration of the head actuator 2 attributable to airflow disturbance can be reduced without providing a separate member, whereby an effect can be obtained to improve the positioning accuracy of the head 3.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A disk device comprising:
a latch configured to retract a head on a distal end portion of an actuator to a ramp near the outer periphery of a disk and to latch a ferromagnet on the actuator on the side of a motor coil by a latch magnet;
a shaft protruding from a base of the disk device near the latch;
a rotary lever configured to pivot on the shaft, the rotary lever comprising a first arm on the disk side extending over the disk in such a manner that the rotary lever is rotated by a pressure of airflow due to rotation of the disk; and
a second arm on the latch magnet side configured to move as the rotary lever is rotated by the airflow pressure, and to weaken magnetic coupling between the latch magnet and the ferromagnet.

2. A disk device of claim 1, wherein a ferromagnetic portion is on a distal end portion of the second arm, the ferromagnetic portion being configured to move and to contact the latch magnet as the rotary lever is rotated by the airflow pressure.

3. The disk device of claim 1, wherein the latch magnet is configured to move, and the second arm is configured to move as the rotary lever is rotated by the airflow pressure, thereby moving the latch magnet away from the ferromagnetic member.

4. The disk device of claim 1, wherein a coil spring is between the rotary lever and the base, the coil spring being configured to return the second arm to a position where the second arm does not interfere with normal magnetic coupling between the latch magnet and the ferromagnet if the rotary lever is not influenced by the airflow pressure.

5. A disk device comprising:
a latch configured to retract a head on a distal end portion of an actuator to a ramp near the outer periphery of a disk and to latch a ferromagnet on the actuator on the side of a motor coil by a latch magnet;
a shaft protruding from a base of the disk device near the latch; and
a rotary lever configured to pivot on the shaft, the rotary lever comprising a first arm of the rotary lever on the disk side extending over the disk in such a manner that the rotary lever is rotated by a pressure of airflow due to rotation of the disk, and a second arm on the latch magnet side,
the latch magnet being on an end portion of the second arm and configured to move away from the ferromagnetic member as the rotary lever is rotated by the airflow pressure.

6. The disk device of claim 5, wherein a coil spring is between the rotary lever and the base, the coil spring being configured to return the latch magnet on the end portion of the rotary lever to a position where the latch magnet is configured to be magnetically coupled to the ferromagnet if the rotary lever is not influenced by the airflow pressure.

7. The disk device of claim 5, wherein the ferromagnet on the actuator on the motor coil side is a yoke of the coil, configured to return the latch magnet on the end portion of the rotary lever to a position where the latch magnet is configured to be magnetically coupled to the ferromagnet by a force configured to attach a magnetic circuit for driving the actuator to the yoke, if the rotary lever is not influenced by the airflow pressure.

8. The disk device of claim 5, wherein a stopper for determining respective stop positions of the actuator and the rotary lever with the disk stationary is on the base between the rotary lever and the shaft-side surface of the motor coil on the actuator.

9. The disk device of claim 1, wherein the first arm is extending to the vicinity of a clamp ring of a spindle motor over the disk in such a manner that the airflow on the upstream side of the rotary lever due to the rotation of the disk is prevented from flowing toward the head on the head actuator.

10. The disk device of claim 9, wherein the shape of the disk-side arm of the rotary lever is curved in such a manner that the airflow on the upstream side of the rotary lever due to the rotation of the disk is guided toward the coil of the head actuator.

11. The disk device of claim 10, wherein the first arm is tabular, and a rib for reinforcing the arm is along the length of the arm on the side of the arm toward or away from the airflow.

12. The disk device of claim 5, wherein the first arm is extending to the vicinity of a clamp ring of a spindle motor over the disk in such a manner that the airflow on the upstream side of the rotary lever due to the rotation of the disk is prevented from flowing toward the head on the head actuator.

13. The disk device of claim 12, wherein the shape of the disk-side arm of the rotary lever is curved in such a manner that the airflow on the upstream side of the rotary lever by the rotation of the disk is guided toward the coil of the head actuator.

14. The disk device of claim 13, wherein the first arm is tabular, and a rib for reinforcing the arm is disposed along the length of the arm on the side of the arm toward or away from the airflow.
